(19) United States
(12) Patent Application Publication
(10) Pub. No.: US 2025/0372839 A1
(43) Pub. Date: Dec. 4, 2025

(54) METHOD OF MANUFACTURING RECHARGEABLE BATTERY AND RECHARGEABLE BATTERY

(71) Applicant: TOYOTA BATTERY CO., LTD., Shizuoka (JP)

(72) Inventor: Yuji KATAYAMA, Okazaki-shi (JP)

(21) Appl. No.: 19/048,357

(22) Filed: Feb. 7, 2025

(30) Foreign Application Priority Data
May 29, 2024 (JP) 2024-086831

(51) Int. Cl. H01M 50/566; H01M 50/103; H01M 50/171; H01M 50/536

(52) U.S. Cl. CPC H01M 50/566; H01M 50/103; H01M 50/171; H01M 50/536

(57) ABSTRACT

Conventional art has a problem in that production efficiency of rechargeable batteries is low. A method of manufacturing a rechargeable battery according to the present disclosure includes: resin-molding a lower case including a storage unit for storing an electrode body and an electrode terminal to be connected to an electrode tab of the electrode body; welding the electrode tab to the electrode terminal from a side of the storage unit of the lower case in a state where the electrode body is taken out of the storage unit; storing the electrode body in the storage unit by bending the electrode tab after the welding of the electrode tab; and gluing a lid to an opening of the lower case in a state where the electrode body is stored in the storage unit.

### INCORPORATION BY REFERENCE

This application is based upon and claims the benefit of priority from Japanese patent application No. 2024-086831, filed on May 29, 2024, the disclosure of which is incorporated herein in its entirety by reference for all purposes.

### BACKGROUND

The present disclosure relates to, for example, a method of manufacturing a rechargeable battery which stores an electrode body and to a rechargeable battery.

In a rechargeable battery, an electrode body which stores and discharges electric power is stored in a case. Accordingly, a technique for storing an electrode body in a case is described in Japanese Unexamined Patent Application Publication No. 2017-162716.

A rechargeable battery described in Japanese Unexamined Patent Application Publication No. 2017-162716 is housed in an electrode plate group-conductive electrical tank. In the electrode plate group, a positive electrode plate and a negative electrode plate are wound with a separator therebetween, the electrode plate group includes a positive electrode portion with a positive electrode plate protruding at one end in a direction orthogonal to a winding direction and a negative electrode portion with a negative electrode plate protruding at the other end in the orthogonal direction, and a resin film is arranged around the electrode plate group. In the electrode plate group, a resin film is glued to a portion (a central portion) between the positive electrode portion and the negative electrode portion.

### SUMMARY

However, in the rechargeable battery described in Japanese Unexamined Patent Application Publication No. 2017-162716, a sub-assembly with a lid to which an external terminal and a current-collecting member are joined is assembled and the sub-assembly is stored in a case after joining the sub-assembly and a wound body to each other. In other words, when assembling the rechargeable battery described in Japanese Unexamined Patent Application Publication No. 2017-162716, there is a problem in that assembly requires many man-hours and production efficiency is low.

The present disclosure has been made in view of the circumstances described above and an object thereof is to increase production efficiency of a rechargeable battery.

A method of manufacturing a rechargeable battery according to the present disclosure includes: resin-molding a lower case including a storage unit for storing an electrode body and an electrode terminal to be connected to an electrode tab of the electrode body; welding the electrode tab to the electrode terminal from a side of the storage unit of the lower case in a state where the electrode body is taken out of the storage unit; storing the electrode body in the storage unit by bending the electrode tab after the welding of the electrode tab; and gluing a lid to an opening of the lower case in a state where the electrode body is stored in the storage unit.

An aspect of a rechargeable battery according to the present disclosure includes: an electrode body; a lower case in which a storage unit for storing the electrode body is molded using a resin and which includes an electrode terminal having been insert-molded using the resin; and a lid which seals the lower case in a state where the electrode body is stored in the storage unit, wherein an electrode tab which is provided so as to protrude from the electrode body is stored in a state where an open end of the electrode tab is welded to the electrode terminal and the electrode tab is bent.

The method of manufacturing a rechargeable battery and the rechargeable battery according to the present disclosure can increase production efficiency by reducing the number of components required to electrically join the external terminal and the electrode body to each other.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram illustrating terminal components of a battery cell according to a first embodiment;

FIG. 2 is a diagram illustrating a lower case molding step according to the first embodiment;

FIG. 3 is a diagram illustrating a first example of a tab welding step and an electrode body storing step according to the first embodiment;

FIG. 4 is a diagram illustrating a second example of the tab welding step and the electrode body storing step according to the first embodiment; and

FIG. 5 is a diagram illustrating a sealing step according to the first embodiment.

### DESCRIPTION OF EMBODIMENTS

In the following description and in the drawings, omissions and abridgments have been made when appropriate for the sake of clarity. In the respective drawings, same elements are denoted by same reference signs and repetitive descriptions are omitted as needed. In addition, in the following description, a direction in which a long side of a battery cell extends is defined as a width direction X, a direction in which a short side of the battery cell extends is defined as a thickness direction Z, and a direction which is orthogonal to the width direction X and the thickness direction Z and which represents a height of the battery cell is defined as a height direction Y. Furthermore, in the following description, the width direction X may be referred to as a left-right direction and the height direction Y may be referred to as an up-down direction. Moreover, in the example to be described below, it is assumed that the battery cell is made up of two electrode bodies arranged in the width direction X of one battery case.

### First Embodiment

A method of manufacturing a rechargeable battery according to a first embodiment includes a lower case molding step, a tab welding step, an electrode body storing step, and a sealing step. The lower case molding step involves resin-molding a lower case including a storage unit for storing an electrode body and an electrode terminal to be connected to an electrode tab of the electrode body. While an example of a rechargeable battery in which two electrode bodies are stored in one case and two electrode bodies connected in series constitute one battery cell will be described below, the method of manufacturing a rechargeable battery according to the first embodiment can be applied to any rechargeable battery as long as one or more electrode bodies are stored in one case.

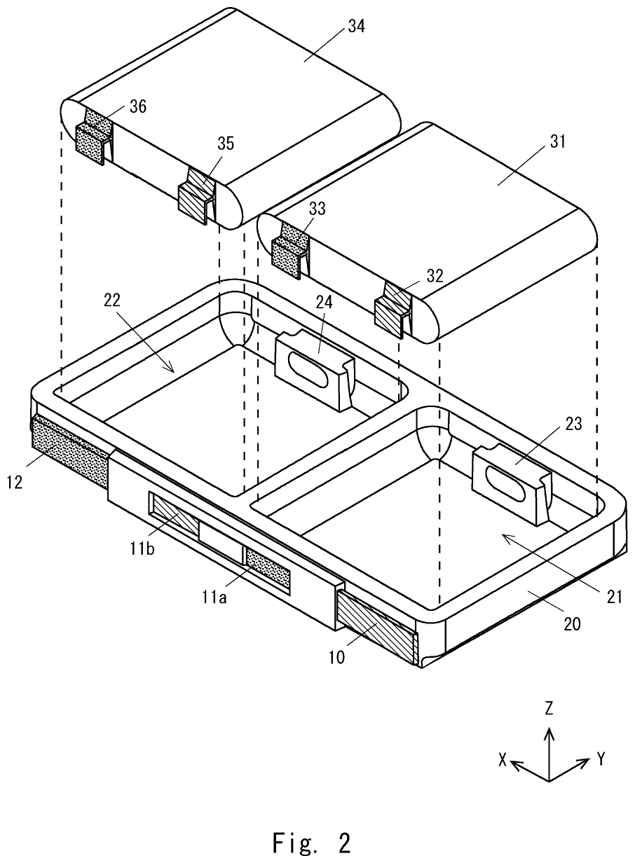

The tab welding step involves welding the electrode tab to the electrode terminal from a side of the storage unit of the lower case in a state where the electrode body is taken out of the storage unit. The electrode body storing step performed after the tab welding step involves storing the electrode body in the storage unit by bending the electrode tab. The sealing step involves welding a lid to an opening of the lower case in a state where the electrode body is stored in the storage unit. Hereinafter, the lower case molding step, the tab welding step, the electrode body storing step, and the sealing step will be described with reference to FIGS. 2 to 5.

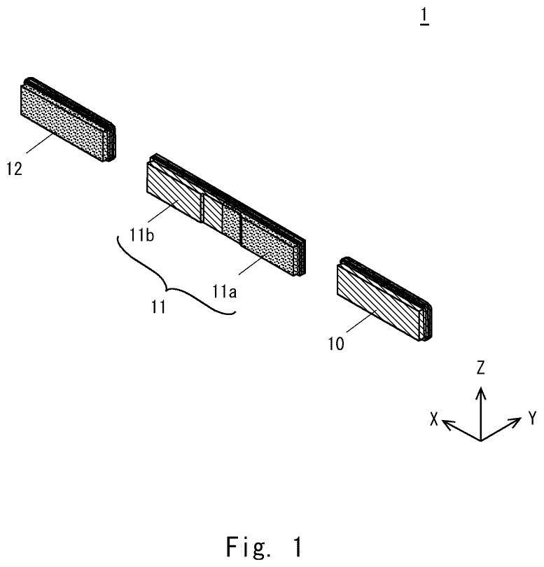

In a battery cell 1 described in the first embodiment, an electrode terminal is insert-molded in a lower case. Accordingly, the electrode terminal in a state prior to being insert-molded in the lower case will be described. FIG. 1 shows a schematic diagram illustrating terminal components of the battery cell according to the first embodiment.

As shown in FIG. 1, the battery cell 1 according to the first embodiment has a first external terminal (for example, an external positive electrode terminal 10) and a second external terminal (for example, an external negative electrode terminal 12) as electrode terminals. In addition, the battery cell 1 according to the first embodiment has an intermediate terminal 11 which electrically connects two electrode bodies to be stored in the lower case to each other. Furthermore, a first electrode tab (for example, a positive electrode tab) of a first electrode body is connected to the external positive electrode terminal 10. When the first electrode tab is a positive electrode, the external positive electrode terminal 10 is formed by a metal containing aluminum as a principal component.

The intermediate terminal 11 electrically connects a second electrode tab (for example, a negative electrode) of the first electrode body and a first electrode tab (for example, a positive electrode) of a second electrode body to each other. Specifically, the intermediate terminal 11 is formed by joining an intermediate negative electrode terminal 11a and an intermediate positive electrode terminal 11b to each other. In addition, the intermediate negative electrode terminal 11a to which the negative electrode tab of an electrode body is connected is formed of a metal containing copper as a principal component and the intermediate positive electrode terminal 11b to which the positive electrode tab of an electrode body is connected is formed of a metal containing aluminum as a principal component. Furthermore, the intermediate terminal 11 is made by integrating the intermediate negative electrode terminal 11a and the intermediate positive electrode terminal 11b using a technique for dissimilar material bonding.

A second electrode tab (for example, a negative electrode) of the second electrode body is connected to the external negative electrode terminal 12. When the second electrode tab is a negative electrode, the external negative electrode terminal 12 is formed by a metal containing copper as a principal component.

In addition, in the method of manufacturing a rechargeable battery according to the first embodiment, the lower case is molded by insert-molding the external positive electrode terminal 10, the intermediate terminal 11, and the external negative electrode terminal 12 in a state of being arranged in a straight line in the width direction X of the battery cell 1 where the electrode bodies are lined up. Accordingly, FIG. 2 shows a diagram illustrating the lower case molding step according to the first embodiment.

As shown in FIG. 2, in the lower case molding step of a rechargeable battery according to the first embodiment, insert molding is performed in which the lower case 20 is molded from resin so as to encapsulate the external positive electrode terminal 10, the intermediate terminal 11, and the external negative electrode terminal 12 in resin. A first storage unit 21 and a second storage unit 22 are formed in the lower case 20. Furthermore, in the lower case 20, the external positive electrode terminal 10, the intermediate terminal 11, and the external negative electrode terminal 12 are arranged on a terminal arrangement surface extending in a direction in which the first storage unit and the second storage unit 22 are adjacent to each other in a surface of the lower case 20 so that the intermediate terminal 11 is located between the external positive electrode terminal 10 and the external negative electrode terminal 12. In this case, the terminal arrangement surface refers to a surface in the lower case 20 which is bounded by first and second sides, in which case the longest side is the first side and the shortest side is the second side. In the example shown in FIG. 2, the first side is a side that extends in the width direction X and the second side is a side that extends in the thickness direction Z.

In addition, the lower case 20 is molded so that surfaces of the external positive electrode terminal 10 and the external negative electrode terminal 12 that face the outside of the lower case 20 and the back surfaces that face the first storage unit 21 and the second storage unit 22 are both exposed. Furthermore, in the intermediate terminal 11, the lower case 20 is molded so that surfaces of the intermediate negative electrode terminal 11a and the intermediate positive electrode terminal 11b that face the outside of the lower case 20 and the back surfaces that face the first storage unit 21 and the second storage unit 22 are both exposed. However, as shown in FIG. 2, the lower case 20 is molded so that the portion of the intermediate terminal 11 where the intermediate negative electrode terminal 11a and the intermediate positive electrode terminal 11b are joined to each other is covered with resin.

In this manner, since covering the junction surface of the intermediate negative electrode terminal 11a and the intermediate positive electrode terminal 11b with resin prevents the junction surface from being exposed to air, corrosion of the junction surface can be prevented.

As shown in FIG. 2, a first electrode body 31 is stored in the first storage unit 21 and a second electrode body 34 is stored in the second storage unit 22. In this storage state according to the first embodiment, a positive electrode tab 32 of the first electrode body 31 is joined to the external positive electrode terminal 10. A negative electrode tab 33 of the first electrode body 31 is joined to the intermediate negative electrode terminal 11a. In addition, in the storage state, a positive electrode tab 35 of the second electrode body 34 is joined to the intermediate positive electrode terminal 11b. A negative electrode tab 36 of the second electrode body 34 is joined to the external negative electrode terminal 12.

In addition, as shown in FIG. 2, a smoke exhaust port 23 is formed in the first storage unit 21 and a smoke exhaust port 24 is formed in the second storage unit 22. The smoke exhaust ports 23 and 24 are provided on a surface (hereinafter, referred to as a case bottom surface) opposite the surface on which the external positive electrode terminal 10, the intermediate terminal 11, and the external negative electrode terminal 12 are provided. The smoke exhaust ports 23 and 24 have a T-shape and are high enough that an upper surface with a large area is in contact with a surface (referred to as an electrode body bottom surface) opposite the surface where the electrode tabs of the first electrode body 31 and the second electrode body 34 are formed. Using the smoke exhaust ports 23 and 24, the battery cell 1 supports the bottom surfaces of the electrode bodies in the storage state with the members that constitute the smoke exhaust ports.

In addition, the smoke exhaust ports 23 and 24 are provided with holes that penetrate through a member formed in a shape that supports the first electrode body 31 and the second electrode body 34. Furthermore, an open valve (not illustrated) is provided in the holes to discharge gas inside each storage unit to the outside when the internal pressure of the storage unit rises. Due to the open valve, the battery cell 1 is designed so that the internal pressure in the storage units does not rise beyond a certain level.

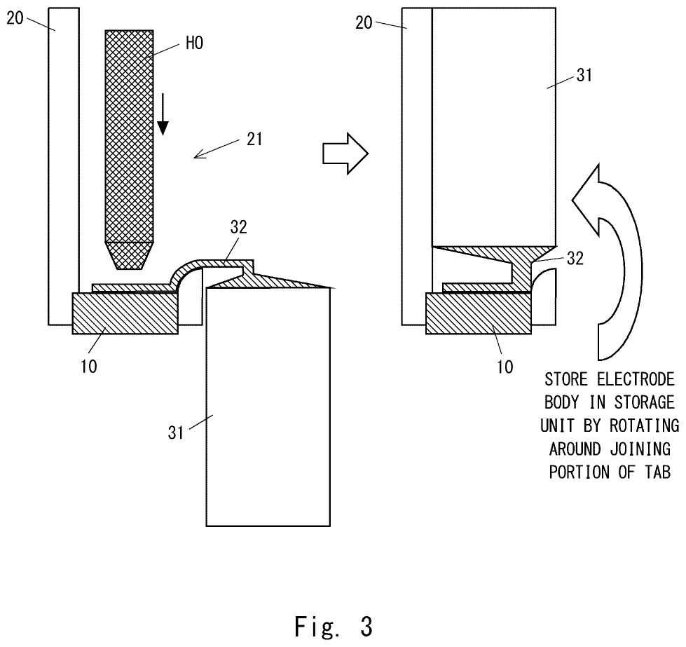

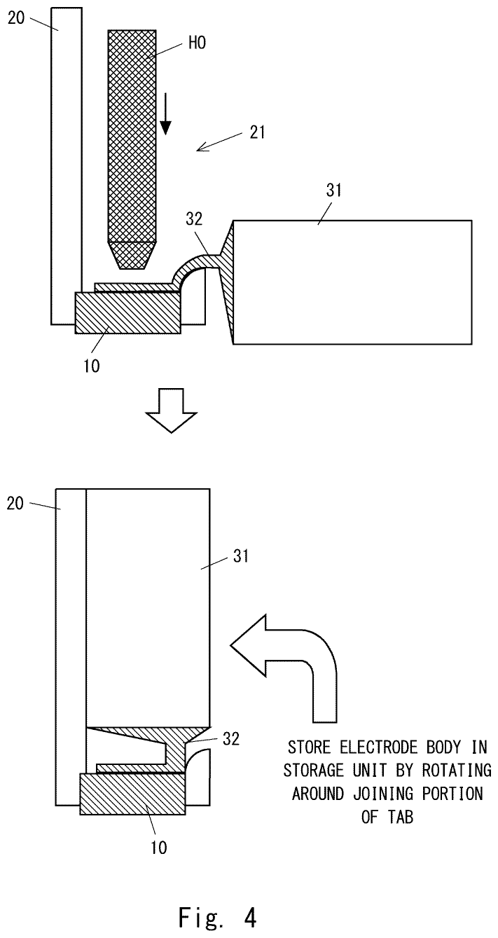

As shown in FIG. 2, electrode tabs include an electrode tab for a positive electrode (for example, the positive electrode tab 32 and the positive electrode tab 35) and an electrode tab for a negative electrode (for example, the negative electrode tab 33 and the negative electrode tab 36), with the electrode tab for a positive electrode and the electrode tab for a negative electrode provided so as to protrude from one side surface of the electrode body. In the method of manufacturing a rechargeable battery according to the first embodiment, the electrode body is stored in a storage unit by implementing the electrode body storing step after implementing the tab welding step. Accordingly, FIG. 3 shows a diagram illustrating a first example of the tab welding step and the electrode body storing step according to the first embodiment, and FIG. 4 shows a diagram illustrating a second example of the tab welding step and the electrode body storing step according to the first embodiment. While FIGS. 3 and 4 show a part of a cross section which extends in the height direction Y including the external positive electrode terminal 10, the same tab welding step is also implemented with respect to the intermediate terminal 11 and the external negative electrode terminal 12.

In the first example shown in FIG. 3, the first electrode body 31 is arranged so as to be parallel to a side surface of the lower case 20 (for example, a surface which extends along the height direction Y and into which a surface with the widest area of the electrode body stored in the storage unit comes into contact) and the positive electrode tab 32 is bent so that the positive electrode tab 32 comes into contact with a surface on the side of the first storage unit 21 of the external positive electrode terminal 10. In addition, a horn HO that is a tool for performing ultrasonic joining is pressed against the positive electrode tab 32 from a side of the first storage unit 21 so as to press the positive electrode tab 32 against the external positive electrode terminal 10. Furthermore, although not illustrated, when performing ultrasonic joining, an anvil (receiving jig) is pressed against the external positive electrode terminal 10 from a direction opposite the horn HO.

In the second example shown in FIG. 4, the first electrode body 31 is arranged so as to be perpendicular to the side surface of the lower case 20 and the positive electrode tab 32 is arranged so that the positive electrode tab 32 comes into contact with the surface on the side of the first storage unit 21 of the external positive electrode terminal 10. In addition, the horn HO is pressed against the positive electrode tab 32 from the side of the first storage unit 21 so as to press the positive electrode tab 32 against the external positive electrode terminal 10.

In this manner, a large space can be secured above the positive electrode tab 32 when the positive electrode tab 32 is arranged on the external positive electrode terminal 10. In other words, in the method of manufacturing a rechargeable battery according to the first embodiment, high workability can be achieved because a large space (for example, a tooling space) can be secured for tools such as the horn HO.

After the joining of the external positive electrode terminal 10 and the positive electrode tab 32 is completed, the electrode body storing step is implemented in both the first example shown in FIG. 3 and the second example shown in FIG. 4. In the electrode body storing step, the positive electrode tab 32 is stored in the first storage unit 21 by rotating the first electrode body 31 around a joining portion of the external positive electrode terminal 10 and the positive electrode tab 32.

By storing the first electrode body 31 in the first storage unit 21 so as to rotate the first electrode body 31 in a state where the positive electrode tab 32 is joined to the external positive electrode terminal 10, the method of manufacturing a battery according to the first embodiment enables man-hours for assembly to be reduced by reducing the number of components for electrically connecting the first electrode body 31 and the external positive electrode terminal 10 to each other.

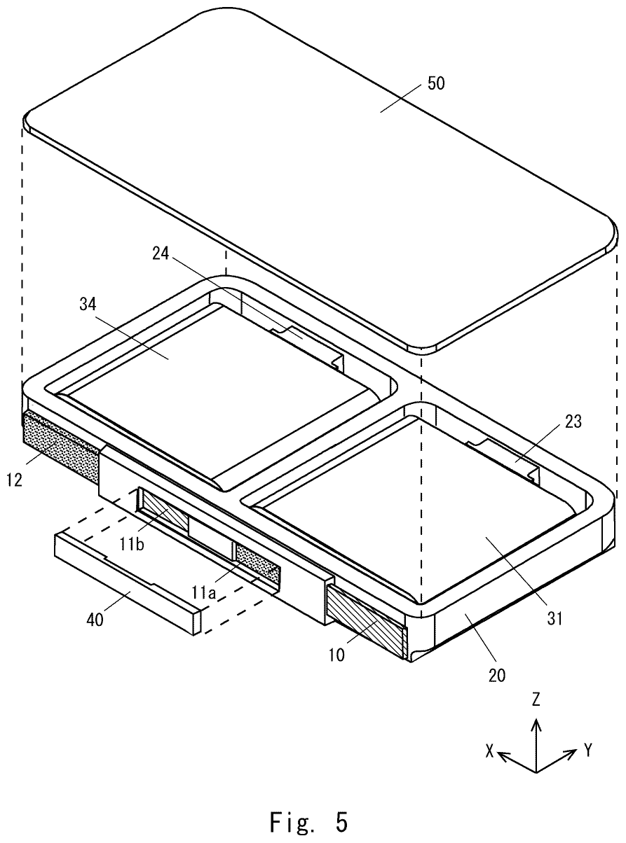

Next, FIG. 5 shows a diagram illustrating the sealing step according to the first embodiment. FIG. 5 is a diagram that illustrates a state in which an insulating cover 40 and a lid 50 are attached to the lower case 20 in which the first electrode body 31 and the second electrode body 34 illustrated in FIG. 2 are stored in the respective storage units. In the battery cell 1 according to the first embodiment, the lid 50 is glued to the lower case 20 so as to cover the first storage unit 21 and the second storage unit 22 in a state where, after implementing a solution injecting step of injecting an electrolytic solution into each storage unit and impregnating each electrode body with the electrolytic solution after storing the first electrode body 31 and the second electrode body 34 in the respective storage units, remaining excess electrolytic solution has been removed. The lid 50 is glued to the lower case 20 so as to cover the surface with a widest area of the lower case 20. In addition, the insulating cover 40 is fitted into a portion where the intermediate negative electrode terminal 11a and the intermediate positive electrode terminal 11b are exposed to the outside.

At least a surface of the insulating cover 40 is formed of an insulator. In one example, the insulating cover 40 is formed of an insulating material such as aluminum nitride. The insulating cover 40 has a shape that comes into contact with the intermediate negative electrode terminal 11a and the intermediate positive electrode terminal 11b that are exposed to the outside after resin formation. In this case, the insulating cover 40 preferably has a higher thermal conductivity than the resin that constitutes the lower case 20. Forming the insulating cover 40 with a material with a high thermal conductivity in this manner enables the insulating cover 40 to function as a heat-dissipating component that promotes the release of heat generated by the battery cell 1. In other words, using a member that has high insulation and heat dissipation as the insulating cover 40 enables the insulating cover 40 to have both insulation and heat dissipation functions.

Although FIG. 5 shows an example where one lid 50 is provided with respect to two storage units, the lid 50 can be prepared as a separate member for each storage unit. In this manner, by providing a lid for each storage unit, advantageous effects can be obtained including being able to easily weld the lids and being able to change the shape of the lid according to the variation of each electrode body and adjust applied pressure to each electrode body.

A rechargeable battery manufactured through the steps illustrated in FIGS. 2 to 5 includes: a first electrode body 31 and a second electrode body 34; a lower case 20 in which a storage unit for storing the first electrode body 31 and the second electrode body 34 is molded using a resin and which includes an electrode terminal having been insert-molded using the resin; and a lid 50 which seals the lower case in a state where the first electrode body 31 and the second electrode body 34 are stored in the storage unit, in which an electrode tab provided so as to protrude from the first electrode body 31 and the second electrode body 34 is stored in a state where an open end of the electrode tab is welded to the electrode terminal (for example, the external positive electrode terminal 10, the intermediate terminal 11, and the external negative electrode terminal 12) and the electrode tab is bent.

From the description given above, in the method of manufacturing a rechargeable battery according to the first embodiment, the external positive electrode terminal 10 and the external negative electrode terminal 12 which are external terminals and the intermediate terminal 11 which electrically connects two electrode bodies are each integrally molded as a plate-shaped member. In addition, in the method of manufacturing a rechargeable battery according to the first embodiment, the external positive electrode terminal 10, the intermediate terminal 11, and the external negative electrode terminal 12 are integrated with the lower case 20 by insert molding. Furthermore, in the method of manufacturing a rechargeable battery according to the first embodiment, an electrode tab of the electrode bodies is joined to the external positive electrode terminal 10, the intermediate terminal 11, and the external negative electrode terminal 12 which are exposed to a side of the storage unit of the lower case 20, and the electrode bodies are stored in the storage unit by rotating the electrode bodies around the joining portion. Storing the electrode bodies in the storage unit of the lower case through the steps described above enables the number of components to be reduced by substantially limiting members that electrically connects the electrode bodies and the external terminals to each other to only the external terminals. Moreover, the number of manufacturing steps of the rechargeable battery can be reduced by reducing the number of components.

In addition, in the method of manufacturing a rechargeable battery according to the first embodiment, a wide tooling space can be secured above a portion to be joined when joining an electrode tab to the external terminals, the horn HO and the like to be used for joining can be readily inserted, and steps can be readily designed.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims. For example, while the first external terminal has been described as a negative electrode terminal and the second external terminal has been described as a positive terminal in the description given above, reversing the electrode terminals is easily conceivable.

What is claimed is:

1. A method of manufacturing a rechargeable battery, comprising:
resin-molding a lower case including a storage unit for storing an electrode body and an electrode terminal to be connected to an electrode tab of the electrode body;
welding the electrode tab to the electrode terminal from a side of the storage unit of the lower case in a state where the electrode body is taken out of the storage unit;
storing the electrode body in the storage unit by bending the electrode tab after the welding of the electrode tab; and
gluing a lid to an opening of the lower case in a state where the electrode body is stored in the storage unit.

2. The method of manufacturing a rechargeable battery according to claim 1, further comprising impregnating the electrode body with an electrolytic solution between the storing of the electrode body and the gluing of the lid.

3. The method of manufacturing a rechargeable battery according to claim 1, wherein the electrode tab includes an electrode tab for a positive electrode and an electrode tab for a negative electrode, and the electrode tab for a positive electrode and the electrode tab for a negative electrode are provided so as to protrude from one side surface of the electrode body.

4. The method of manufacturing a rechargeable battery according to claim 1, wherein the electrode terminal is fixed in a state of being insert-molded by a resin that forms the lower case.

5. The method of manufacturing a rechargeable battery according to claim 1, wherein
the electrode body includes a first electrode body and a second electrode body,
the lower case includes a first storage unit which stores the first electrode body and a second storage unit which stores the second electrode body,
the electrode terminal includes a first external terminal to which a first electrode tab of the first electrode body is to be welded, an intermediate terminal which electrically connects a second electrode tab of the first electrode body and a first electrode tab of the second electrode body to each other, and a second external terminal to which a second electrode tab of the second electrode body is to be welded, and
the first external terminal, the intermediate terminal, and the second external terminal are arranged on a terminal arrangement surface extending in a direction in which the first storage unit and the second storage unit are adjacent to each other in a surface of the lower case so that the intermediate terminal is located between the first external terminal and the second external terminal.

6. A rechargeable battery, comprising:
an electrode body;
a lower case in which a storage unit for storing the electrode body is molded using a resin and which includes an electrode terminal having been insert-molded using the resin; and
a lid which seals the lower case in a state where the electrode body is stored in the storage unit, wherein
an electrode tab which is provided so as to protrude from the electrode body is stored in a state where an open end of the electrode tab is welded to the electrode terminal and the electrode tab is bent.

7. The rechargeable battery according to claim 6, wherein the lid is glued to the lower case so as to cover a surface with a widest area in the lower case.

8. The rechargeable battery according to claim 6, wherein
the electrode body includes a first electrode body and a second electrode body,
the storage unit includes a first storage unit which stores the first electrode body and a second storage unit which stores the second electrode body, and
the electrode terminal includes a first external terminal to which a first electrode tab of the first electrode body is to be welded, an intermediate terminal which electrically connects a second electrode tab of the first electrode body and a first electrode tab of the second electrode body to each other, and a second external terminal to which a second electrode tab of the second electrode body is to be welded.

9. The rechargeable battery according to claim 8, wherein the first external terminal, the intermediate terminal, and the second external terminal are arranged on a terminal arrangement surface extending in a direction in which the first storage unit and the second storage unit are adjacent to each other in a surface of the lower case so that the intermediate terminal is located between the first external terminal and the second external terminal.
